(19) United States
(12) Patent Application Publication
(10) Pub. No.: US 2025/0300315 A1
(43) Pub. Date: Sep. 25, 2025

(54) SAFETY BATTERY APPARATUS

(71) Applicant: GH INNOVATION LIMITED, Canterbury, Kent (GB)

(72) Inventor: Gary HUDSON, Canterbury (GB)

(73) Assignee: GH INNOVATION LIMITED, Canterbury, Kent (GB)

(21) Appl. No.: 18/863,932

(22) PCT Filed: May 18, 2023
(86) PCT No.: PCT/GB2023/051317

§ 371 Date: Nov. 7, 2024

(30) Foreign Application Priority Data
May 19, 2022 (GB) 2207332.4
Mar. 9, 2023 (GB) 2303494.5

(51) Int. Cl. H01M 50/383; H01M 50/333; H01M 50/581

(52) U.S. Cl. CPC H01M 50/383; H01M 50/333; H01M 50/581

(57) ABSTRACT

A safety battery apparatus comprising a battery housing within which is located one or more rechargeable electrochemical cells, and a heat safety apparatus associated with the battery housing, wherein the heat safety apparatus includes a heat detection apparatus and an electrical switch that forms part of an electrical circuit to which the electrochemical cell(s) are connected and/or forms part of an alarm circuit; the heat detection apparatus comprises a frangible bulb filled with a liquid or gas that is configured to shatter or break at a pre-determined temperature as a result of thermal expansion of the liquid or gas within the bulb, and a biasing element; the heat detection apparatus is operatively coupled to the electrical switch; the switch has an isolation configuration in which the switch isolates the electrical circuit from the electrochemical cells and/or activates the alarm circuit if a pre-determined threshold temperature within the battery housing is exceeded; the biasing element exerts a biasing force which urges the heat detection apparatus to configure the switch in its isolation configuration; the frangible bulb exerts a counterbalance force against the biasing force; and wherein the counterbalance force is removed when the frangible bulb shatters or breaks.

The present invention relates to a safety battery apparatus and in particular to a safety battery apparatus for use with lithium batteries.

An electric battery is a source of electric power consisting of one or more electrochemical cells with external connections for powering electrical devices. Multi cell batteries are commonly contained in casings or enclosures.

Primary (single-use or “disposable”) batteries are used once and discarded, as the electrode materials are irreversibly changed during discharge; a common example is the alkaline battery used for torches and a multitude of portable electronic devices.

Secondary (rechargeable) batteries can be discharged and recharged multiple times using an applied electric current; the original composition of the electrodes can be restored by reverse current. Common examples include lead-acid batteries and lithium-ion batteries,

Batteries come in many shapes and sizes, from miniature cells used to power hearing aids and wristwatches to, at the largest extreme, huge battery banks the size of rooms that provide standby or emergency power supplies for essential equipment including computer data centres.

A lithium-ion battery is a type of rechargeable battery composed of cells in which lithium ions move from the negative electrode through an electrolyte to the positive electrode during discharge and back when charging. Lithium-ion cells use an intercalated lithium compound as the material at the positive electrode and typically graphite at the negative electrode. Lithium-ion batteries have a high energy density and low self-discharge. Cells can be manufactured to either prioritise energy or power density.

Lithium-ion batteries can present a safety hazard as they contain a flammable electrolyte and may become pressurised if they become damaged. Fires resulting from damaged, electrical short-circuits or charging faults in relation to lithium-ion batteries are well known.

Short-circuiting a battery will cause a cell to overheat and possibly catch fire. Smoke from thermal runaway in a Lithium-ion battery is both flammable and toxic.

Thermal runaway describes a process that is accelerated by increased temperature, in turn releasing energy that further increases temperature. Thermal runaway occurs in situations where an increase in temperature changes the conditions in a way that causes a further increase in temperature, often leading to a destructive result.

As Lithium-ion batteries are becoming more widely used in critical functions, it is desired to provide a safer environment for such batteries.

According to a first aspect of the invention, there is provided a safety battery apparatus comprising a battery housing within which is located one or more rechargeable electrical energy storage cells (electrochemical cells), and a heat safety apparatus associated with the battery housing, wherein the heat safety apparatus includes a heat detection apparatus and an electrical switch that forms part of an electrical circuit which is powered by the rechargeable electrical energy cell(s) or which is part of a charging circuit for charging the electrical energy cell(s) located within the battery housing, and/or forms part of an alarm circuit; the heat detection apparatus comprises a frangible bulb filled with a liquid or gas that is configured to shatter or break at a pre-determined temperature as a result of thermal expansion of the liquid or gas within the bulb, and a biasing element; the heat detection apparatus is operatively coupled to the electrical switch; the switch has an isolation configuration in which the switch isolates the electrical circuit from the electrical energy cells and/or activates the alarm circuit if a pre-determined threshold temperature within the battery housing is exceeded; the biasing element exerts a biasing force which urges the heat detection apparatus to configure the switch in its isolation configuration; the frangible bulb exerts a counterbalance force against the biasing force; and wherein the counterbalance force is removed when the frangible bulb shatters or breaks.

In this aspect of the invention, if the frangible bulb shatters as a result of an over-temperature event in which a threshold temperature is exceeded, the counterbalance force is removed and the biasing force exerted by the biasing element urges the heat detection apparatus to move the switch to its isolation configuration. This in turn isolates the electrical circuit from the electrochemical cell(s) and/or activates an alarm circuit. Such actions help to prevent a thermal runaway reaction which could result in a fire within the electrochemical cells.

The term “associated with” as used herein should be construed as meaning that the component (e.g., the heat safety apparatus) is located within the battery housing or is coupled to the battery housing. For example, the component may be disposed within the battery housing or it may be carried externally by a portion or wall of the battery housing.

In an embodiment of the invention, the heat detection apparatus includes an actuator element which is operatively coupled to the switch. In this embodiment, the movement of the actuator element may cause the switch to move from a connected configuration to its isolation configuration. The actuator element may be disposed between the frangible bulb and the biasing element.

Any features discussed hereinafter in connection with the further aspects of the invention or embodiments thereof may form optional features of the first aspect of the invention as defined and discussed hereinabove.

According to a second aspect of the invention, there is provided a retrofit battery safety apparatus. In this aspect of the invention, the battery safety apparatus may be detachably coupled to a battery, such as a rechargeable battery. Thus, the battery safety apparatus of the second aspect of the invention may provide a housing which is detachably coupled to a (rechargeable) battery, wherein the housing contains a heat safety apparatus; wherein the heat safety apparatus includes a heat detection apparatus and an electrical switch that is electrically connected an electrical circuit powered by the (rechargeable) battery and/or is electrically connected to a charging circuit which charges the (rechargeable) battery and/or forms part of an alarm circuit; the heat detection apparatus comprises a frangible bulb filled with a liquid or gas that is configured to shatter or break at a pre-determined temperature as a result of thermal expansion of the liquid or gas within the bulb, and a biasing element; the heat detection apparatus is operatively coupled to the electrical switch; the switch has an isolation configuration in which the switch isolates the electrical circuit from the (rechargeable) battery and/or activates the alarm circuit if a pre-determined threshold temperature within the housing is exceeded; the biasing element exerts a biasing force which urges the heat detection apparatus to configure the switch in its isolation configuration; the frangible bulb exerts a counterbalance force against the biasing force; and wherein the counterbalance force is removed when the frangible bulb shatters or breaks.

As with the first aspect of the invention, the heat detection apparatus may include an actuator element which is operatively coupled to the switch. In such embodiments, the movement of the actuator element may cause the switch to move from a connected configuration to its isolation configuration. The actuator element may be disposed between the frangible bulb and the biasing element.

In a further embodiment of the second aspect of the invention, the housing may define a heat chamber within which the frangible bulb is located. The heat chamber may collect or focus heat energy generated within the (rechargeable) battery. This in turn may increase the sensitivity of the safety apparatus. The heat chamber may be a concave chamber.

The housing may further include a thermally conductive component disposed adjacent to the battery. Thus, the thermally conductive component may form part of the housing which in use faces the battery.

Optionally, the biasing element is a spring.

In a further embodiment of the invention according to its second aspect, the safety battery apparatus includes a connector which is connected to a battery, wherein the housing is detachably coupled to the connector. This, the connector may be fixed to a battery and the housing may be attached to the connector or detached from the connector as desired. For example, the housing may be attached to the connector when the battery is being charged and it may be disconnected from the battery when the battery is being used to power an electrical circuit.

Suitably, the housing may be detachably coupled to the connector via one or more two-part couplings, wherein the connector includes a first part of the or each coupling and the housing includes a second part of the or each coupling.

For example, each two-part coupling may form a snap-fit coupling, a friction coupling or a magnetic coupling.

All of the optional features discussed herein in connection with the aspects of the invention and the embodiments thereof may form optional features of the safety battery apparatus according to the second aspect of the invention.

According to a third aspect of the invention, there is provided a combination of a battery and a safety battery apparatus according to the second aspect of the invention. Optionally, the battery is a rechargeable battery.

In an embodiment of the invention according to its third aspect, a connector is secured to the battery and the housing of the safety battery apparatus is detachably coupled to the connector.

According to a fourth aspect of the invention, there is provided a safety battery apparatus comprising a battery housing within which is located one or more rechargeable electrical energy storage cells (electrochemical cells), and a fire detection and suppression apparatus, wherein the fire detection and suppression apparatus comprises a heat activated mechanical element associated with the battery housing, a fire suppressor comprising a reservoir containing a fire suppressant material and a valve disposed between the reservoir and the battery housing, wherein the valve has a first configuration in which the fire suppressant material is prevented from entering the battery housing, and a second configuration in which the fire suppressant material is permitted to enter the battery housing; wherein the heat activated mechanical element is coupled to the valve and urges the configuration of the valve to change from its first configuration to its second configuration if a pre-determined threshold temperature within the battery housing is exceeded.

The fourth aspect of the invention therefore provides an apparatus which prevents or minimises the risk of fire and/or a thermal runaway associated with a battery, such as a lithium-ion battery. This is achieved by introducing a fire suppressant material into a battery housing in the event that an “over-temperature” event is detected within the housing.

The term “associated with” has the same meaning as given above, namely the heat activated mechanical element may be located within the battery housing or is coupled to the battery housing. For example, the component may be disposed within the battery housing or it may be carried externally by a portion or wall of the battery housing.

In an embodiment of the invention, the apparatus further includes an electrical switch that forms part of an electrical circuit to which the electrochemical cell(s) are connected and/or forms part of an alarm circuit; the heat activated mechanical element is operatively coupled to the switch; and the switch isolates the electrical circuit from the electrochemical cell(s) and/or activates the alarm circuit if a pre-determined threshold temperature within the battery housing is exceeded. Thus, in addition to causing a fire suppressant material to enter the battery housing, the heat activated mechanical element may also change the configuration of an electrical switch. This may, in turn, isolate an electrical circuit from the electrical energy storage cells and/or trigger an alarm. Both of which actions may prevent or minimise damage to the electrical energy storage cells and to any electrical devices or circuitry connected to the electrical energy storage cells.

Accordingly, the heat activated mechanical element may be connected to both the fire suppressant valve and an electrical switch.

The heat activated mechanical element is suitably disposed within a container. In this way, the fire detection and suppression apparatus may be removed, replaced or serviced more easily.

The safety battery apparatus of the fourth aspect of the invention may include one or more heat sensitive components which sense if a temperature within the battery housing exceeds a predetermined threshold temperature value. For example, the invention may include a single heat sensitive component or it may include an array of two of more heat sensitive components. It will be appreciated that the inclusion of two or more heat sensitive components allows the apparatus to sense the temperature within different parts of the battery housing or increases the sensitivity of the apparatus. The use of more than one heat sensitive component may further provide a redundant back-up in the event that there is a fault in another one of the heat sensitive components.

In a further embodiment of the invention, the heat sensitive component includes a frangible bulb filled with a liquid or gas that is configured to shatter or break at a pre-determined temperature as a result of thermal expansion of the liquid or gas within the bulb; an alloy component that is arranged to melt and fail at a predetermined temperature; an intumescent material; or a bimetallic strip.

It will be appreciated that the heat activated mechanical element may include an operative arm. The operative arm may be displaced (i.e., driven) by the thermal expansion of the liquid or gas from the bulb, or the bulb may counterbalance a biasing force exerted on the operative arm, wherein the biasing force drives the displacement of the operative arm when the bulb shatter or breaks (i.e., releasing the biasing force to drive the operative arm).

In the case of an alloy component that melts and fails at a predetermined temperature, the alloy component may counterbalance a biasing force exerted on the operative arm in a similar way to that described above. Accordingly, when the alloy component melts and fails, the biasing force is no longer counterbalanced and drives a displacement of the operative arm.

The skilled person will appreciate that an intumescent material is a material that expands upon being heated. In such cases, the expansion of the intumescent material when it is heated above the predetermined threshold temperature drives the displacement of the operative arm.

The operation of a bimetallic strip to drive an operative arm is well known and need not be described or discussed in detail herein.

Thus, the heat activated mechanical element may further include an operative arm; wherein the operative arm is coupled to the heat sensitive component; and wherein the operative arm has an inactive configuration and an active configuration, wherein the operative arm is urged into its active configuration if a pre-determined threshold temperature within the battery housing is exceeded. Suitably, the operative arm is displaced from its inactive configuration to its active configuration.

As noted above, the operative arm may be biased towards its active configuration. In such embodiments, the biasing force may be counterbalanced by the heat sensitive component. In such embodiments, the heat sensitive component may be arranged to fail at the predetermined temperature. The failure of the heat sensitive component removes the counterbalancing force and permits the biasing force to drive the displacement of the operative arm to its active configuration.

As also noted above, the operative arm may be connected to the fire suppressant valve and optionally an electrical switch.

In an embodiment of the invention, the reservoir containing the fire suppressant material is located externally of the battery housing. This results in an arrangement in which the space within the battery housing is fully available for the electrochemical cells. It also makes it easier to maintain and, if necessary, replace the fire suppressant reservoir without disturbing the battery apparatus or disconnecting it from its electrical circuit(s).

The fire suppressant material may be selected from a non-flammable gas, a non-flammable liquid, a non-flammable foam precursor, a non-flammable powder or mixtures thereof. In the case of a gas and/or a liquid, these materials may be pressurised such that the opening of the valve causes the material to be urged into the battery housing. However, in the case of a powder, the fire suppressant material may include a pressurised carrier in order to carry the powder into the battery housing when the valve is opened.

The heat activated mechanical element is suitably located within a cavity or container defined by or carried by a lid component of the battery housing. In other words, the heat activated mechanical element container discussed hereinabove may form part of or be defined by the lid of the battery housing. In such embodiments, the lid component of the battery housing may be formed from a thermally conductive material such that the heat from within the battery housing is conducted to the heat activated mechanical element.

The skilled person will appreciate that the heat energy may dissipate before it reaches the heat activated mechanical element. This may delay or prevent the operation of the heat activated mechanical element. To address this issue, the lid may include a heat directing element arranged around its periphery (in other words, around the peripheral edge of the lid). The heat directing element prevents or minimises the dissipation of the heat energy away from the heat activated mechanical element. Thus, it “focuses” the heat energy from within the battery housing towards the heat activated mechanical element.

A potential issue in connection with the embodiment described immediately above may arise where battery housings are stacked vertically. In such arrangements, heat energy from the lower battery housings may rise to the upper battery housings and a “false positive” may result. This potential problem may be addressed by providing the lid component with a cover. Suitably, the cover is formed from a thermally insulating material.

More than one of the safety battery apparatus of the fourth aspect of the invention may be combined to form a safety battery module. Thus, according to a fifth aspect of the invention, there is provided a safety battery module comprising an array of two or more safety battery apparatus according to the fourth aspect of the invention as defined herein. In an embodiment of the invention according to its fifth aspect, each battery housing may include a respective heat activated mechanical element and valve; and wherein each valve is connected to a common reservoir containing the fire suppressant material. Thus, each of the safety battery apparatus may be as defined herein in connection with the fourth aspect of the invention, but each of the valves is connected to a reservoir that is common to all of the safety battery apparatus within the battery module.

Suitably, the two or more of the safety battery apparatus that form the safety battery module are disposed within a container.

The or each reservoir which contains the fire suppressant material may be disposed within the container or located externally from the container.

In such arrangements, each safety battery module may have an output voltage of 12, 24 or 48 volts.

In large battery installations, a plurality of battery apparatus are arranged within a container (known as a drawer) to form a battery module and a plurality of such battery modules are arranged vertically within what is known as a cabinet. Thus, according to a sixth aspect of the invention, there is provided a battery energy storage system comprising two or more safety battery modules according to the fifth aspect of the invention, wherein the modules are arranged vertically within a cabinet.

In an embodiment of the sixth aspect of the invention, there is provided one or more reservoirs which contain fire suppressant material, wherein the or each reservoir is common to an electrochemical cell, an array of electrochemical cells, a safety battery module or a battery energy storage system.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

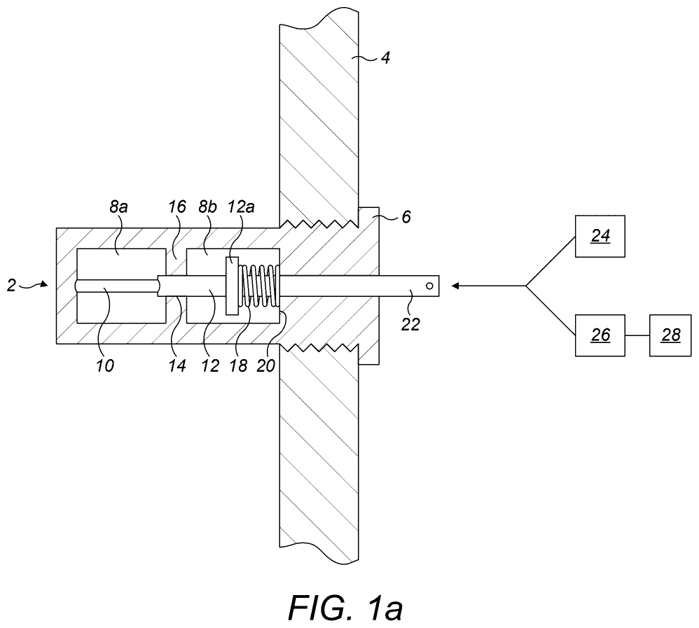

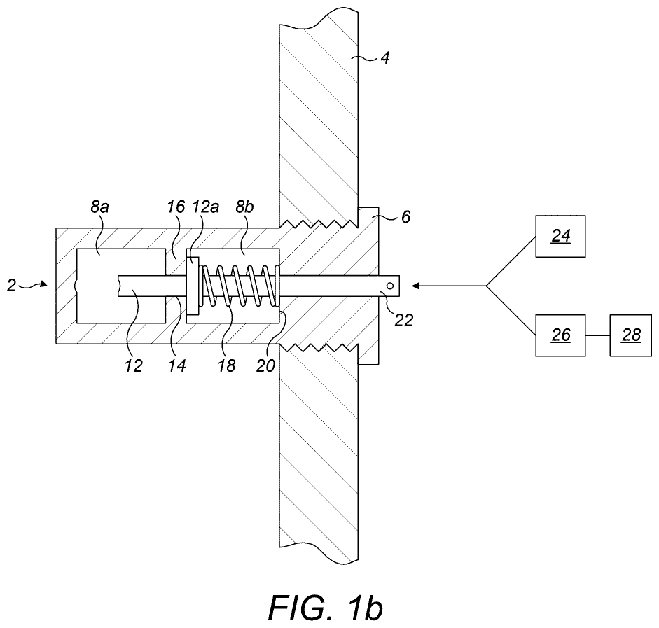

FIG. 1a shows a first embodiment of the invention in which the frangible bulb is intact;

FIG. 1b shows the embodiment shown in FIG. 1a with the frangible bulb shattered;

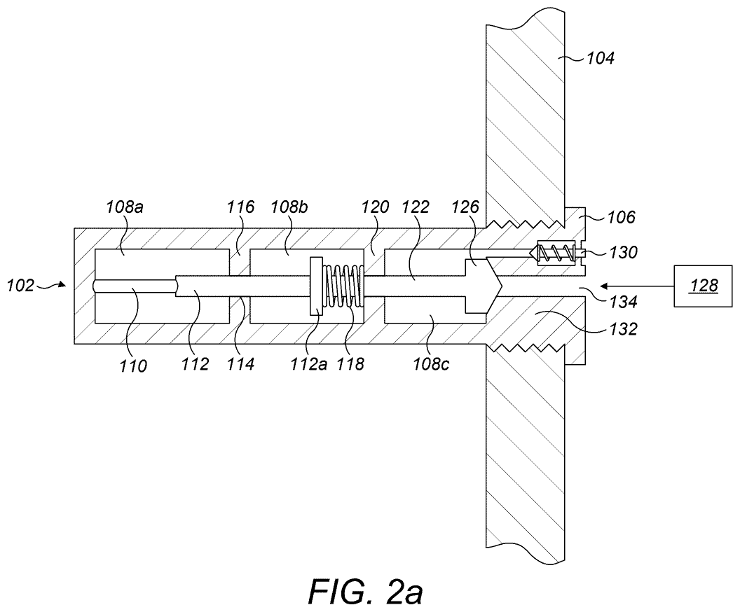

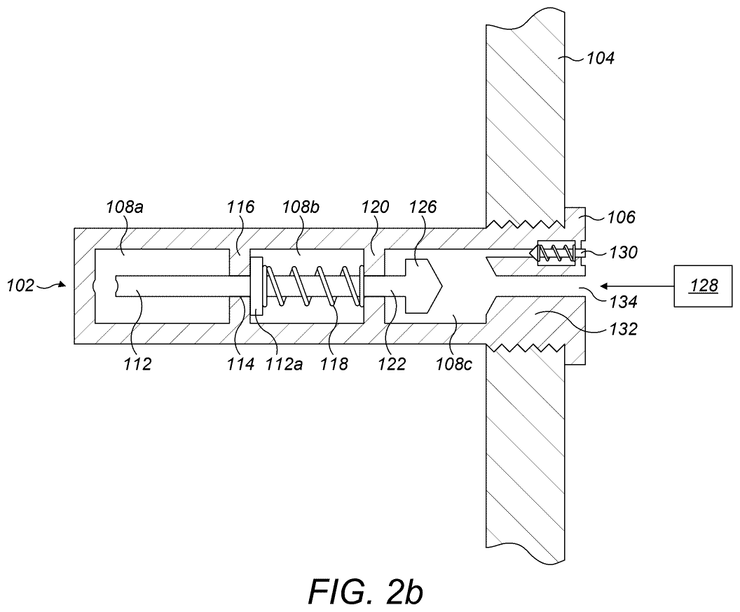

FIG. 2a shows a second embodiment of the invention in which the frangible bulb is intact;

FIG. 2b shows the embodiment shown in FIG. 2a with the frangible bulb shattered;

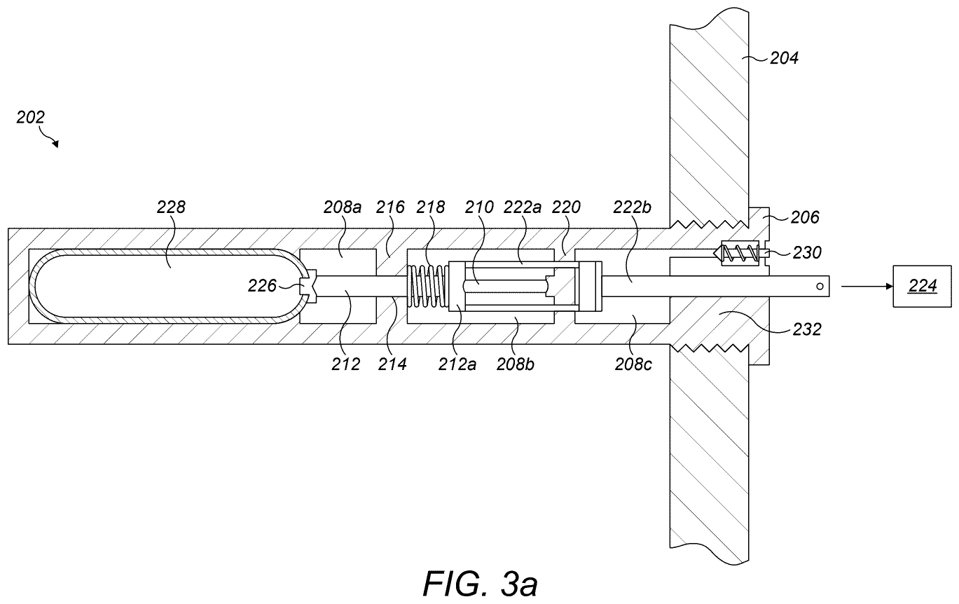

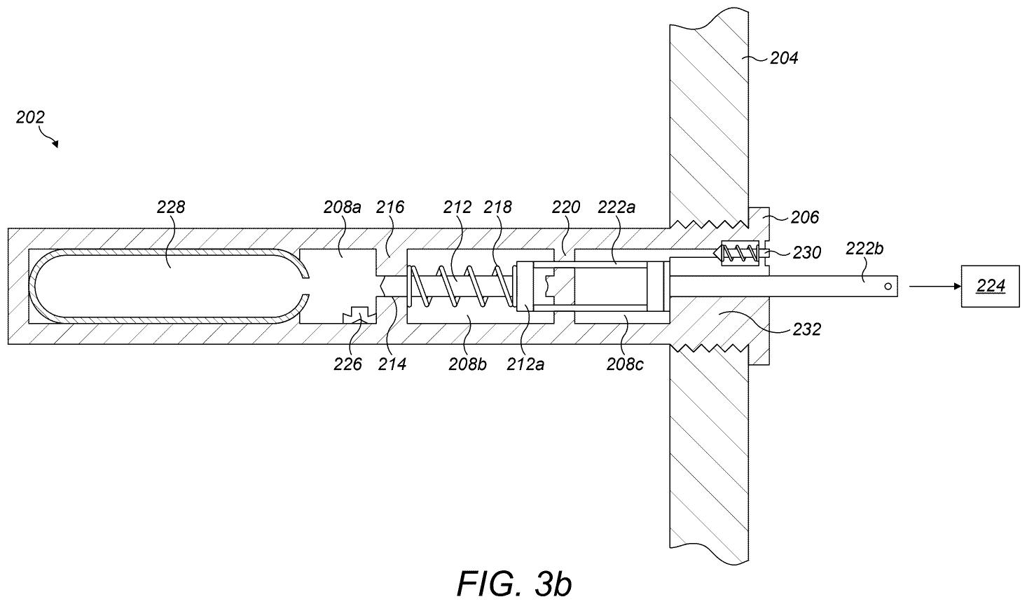

FIG. 3a shows a third embodiment of the invention in which the frangible bulb is intact;

FIG. 3b shows the embodiment shown in FIG. 3a with the frangible bulb shattered;

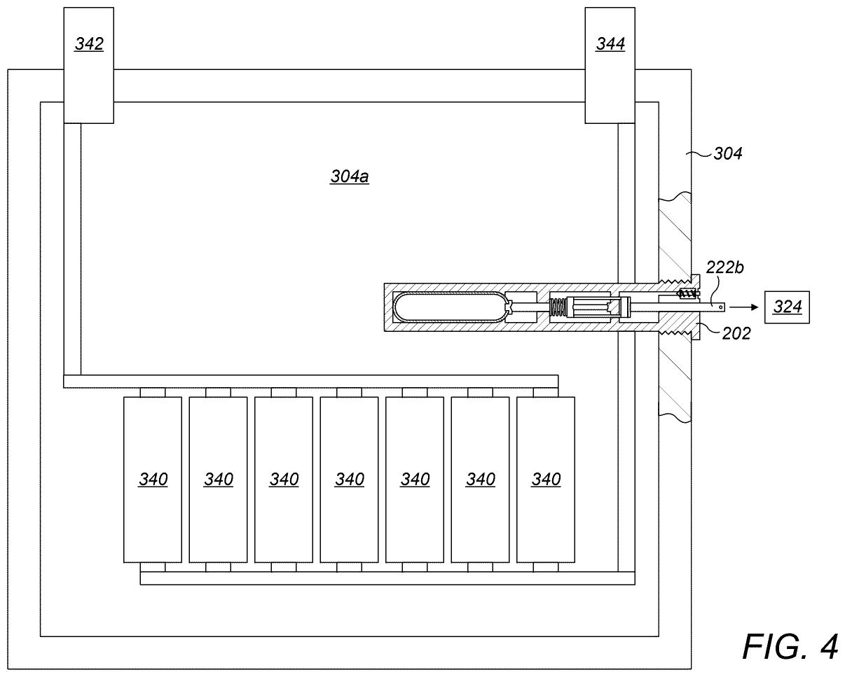

FIG. 4 shows a safety battery module according to the second aspect of the invention;

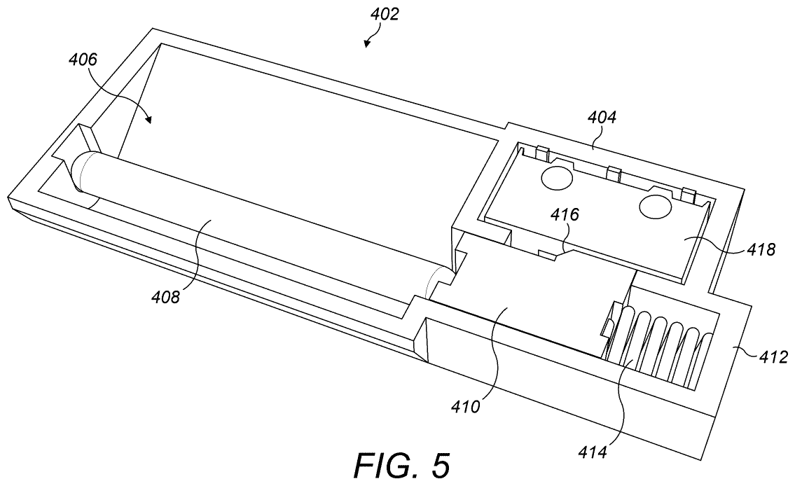

FIG. 5 shows a first embodiment of a safety battery apparatus according to the second aspect of the invention;

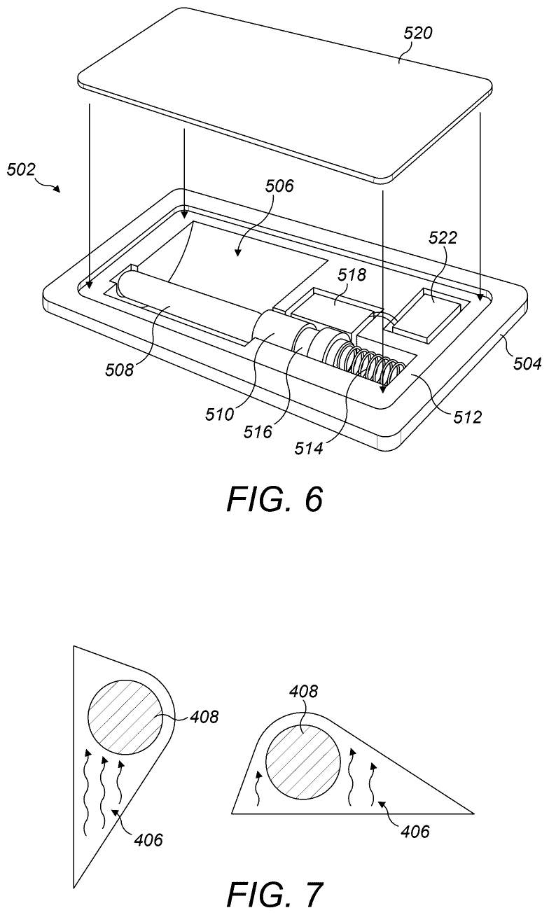

FIG. 6 shows a second embodiment of a safety battery apparatus according to the second aspect of the invention;

FIG. 7 shows a cross-section through a heat chamber of the apparatus shown in FIGS. 5 and 6;

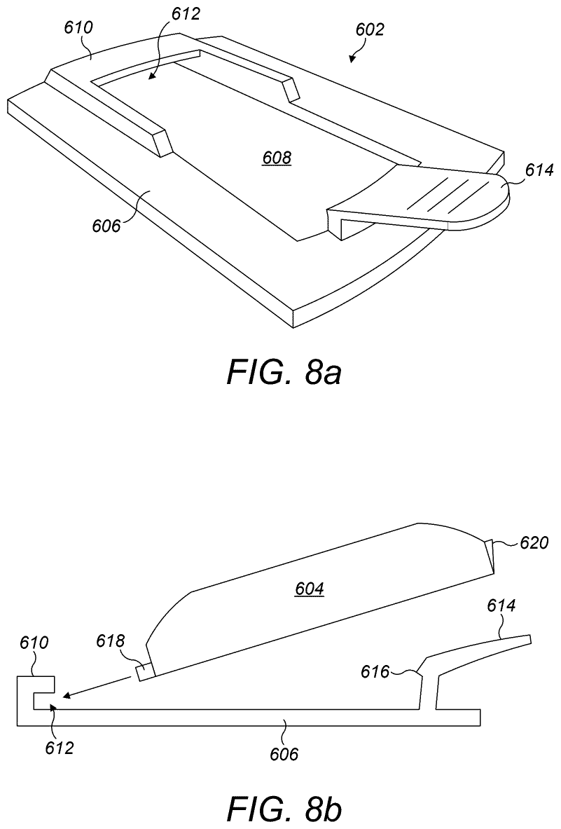

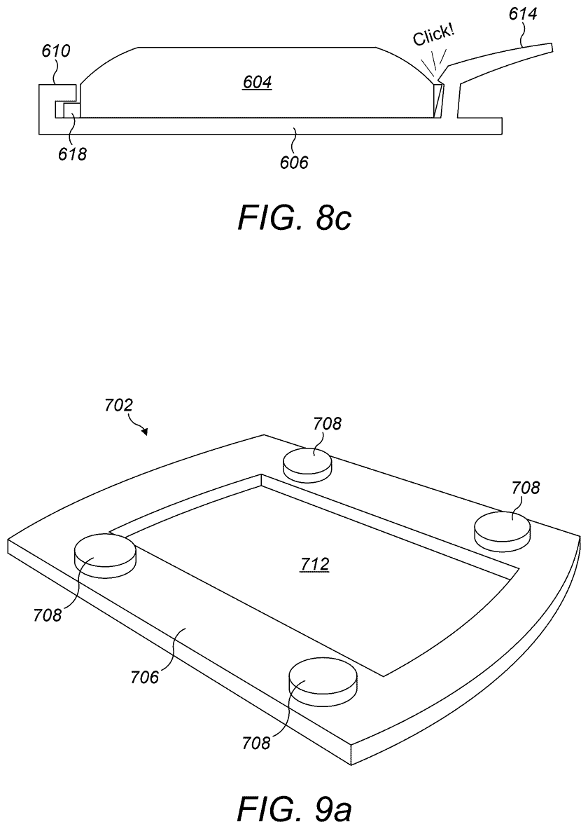

FIG. 8a shows a first embodiment of a connector which forms part of the second aspect of the invention;

FIGS. 8b and 8c show a safety battery apparatus connecting to the connector shown in FIG. 8a;

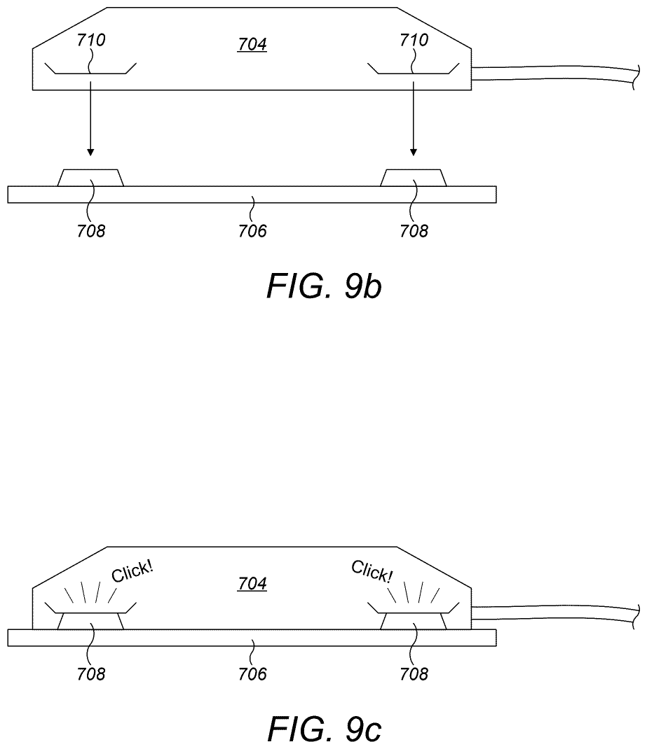

FIG. 9a shows a second embodiment of a connector which forms part of the second aspect of the invention; and

FIGS. 9b and 9c show a safety battery apparatus connecting to the connector shown in FIG. 9a.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIGS. 1a and 1b shows a heat activated mechanical element 2 which is connected to a battery housing 4.

The heat activated mechanical element 2 includes a housing 6, which passes through a wall of the battery housing 4 and is coupled thereto via a threaded coupling. The housing 6 defines a first chamber 8a within which a frangible bulb 10 is disposed.

Frangible bulbs are well known in the art and are typically used in fire sprinkler systems. The frangible bulb has approved characteristics and is designed to fail/shatter/break at a pre-determined temperature. In view of the above, it is not necessary to discuss in detail the frangible bulb 10 herein.

The frangible bulb 10 is connected to one end of a piston 12 which is disposed within a cylinder 14 defined by a first wall 16 of the housing 6. The opposite end of the piston 12 defines an enlarged head portion 12a which is engaged by a coil spring 18 disposed between the head portion 12a of the piston 12 and a second wall 20 of the housing 6. It will be appreciated that the first wall 16 and the second wall 20 of the housing 6 define between them a second chamber 8b and the head portion 12a of the piston 12 and the coil spring 18 are disposed in the second chamber 8b

The coil spring 18 biases the piston 12 towards the frangible bulb 10. The biasing force exerted by the coil spring 18 is balanced by an opposing force exerted by the frangible bulb 10. Thus, the piston 12 remains stationary while the frangible bulb 10 remains intact (as shown in FIG. 1a).

Extending from the enlarged head portion 12a of the piston 12 away from the frangible bulb 10 is an actuating arm 22 which passes through a bore defined by the housing 6 and projects outside of the battery housing 4. The actuating arm 22 is operatively connected to an electrical switch 24 and/or a fire suppressant valve 26.

When the actuating arm 22 is in the configuration shown in FIG. 1a (i.e., with the frangible bulb 10 intact), the electrical switch 24 is in a configuration which electrically connects an electrical circuit (not shown) to the electrochemical cells (shown in FIG. 4) disposed within the battery housing 4. Additionally or alternatively, when the actuating arm 22 is in the configuration shown in FIG. 1a, the fire suppressant valve 26 which controls the flow of a fire suppressant material from a reservoir 28 to the battery housing 4 is in a closed configuration which prevents the flow of the fire suppressant material from the reservoir 28.

FIG. 1b shows the heat activated mechanical element 2 when the temperature within the battery housing 4 has exceeded a pre-determined threshold temperature and the frangible bulb 10 has shattered. In this case, the opposing force exerted by the frangible bulb 10 is removed and the biasing force exerted by the coil spring 18 urges the piston 12 into the first chamber 8a, which in turn displaces the actuating arm 22 in the same direction (i.e., towards the first chamber 8a).

The displacement of the actuating arm 22 causes the configuration of the electrical switch 24 to change to an isolating configuration in which the electrical circuit is isolated from the electrochemical cells disposed within the battery housing 4. Additionally or alternatively, the displacement of the actuating arm 22 opens the fire suppressant valve 26, which in turn permits the flow of fire suppressant material from the reservoir 28 to the interior of the battery housing 4.

FIGS. 2a and 2b show a second embodiment of the heat activated mechanical element 102.

The arrangement of the heat activated mechanical element 102 is similar to that of the heat activated mechanical element 2 described hereinabove.

Accordingly, the heat activated mechanical element 102 includes a housing 106, which passes through a wall of the battery housing 104 and is coupled thereto via a threaded coupling. The housing 106 defines a first chamber 108a within which a frangible bulb 110 is disposed.

The frangible bulb 110 is connected to one end of a piston 112 which is disposed within a cylinder 114 defined by a first wall 116 of the housing 106. The opposite end of the piston 112 defines an enlarged head portion 112a which is engaged by a coil spring 118 disposed between the head portion 112a of the piston 112 and a second wall 120 of the housing 106. It will be appreciated that the first wall 116 and the second wall 120 of the housing 106 define between them a second chamber 108b and the head portion 112a of the piston 112 and the coil spring 118 are disposed in the second chamber 108b

The coil spring 118 biases the piston 112 towards the frangible bulb 110. The biasing force exerted by the coil spring 118 is balanced by an opposing force exerted by the frangible bulb 110. Thus, the piston 112 remains stationary while the frangible bulb 110 remains intact (as shown in FIG. 2a).

Extending from the enlarged head portion 112a of the piston 112 away from the frangible bulb 110 is an actuating arm 122 which passes through a bore defined by the second wall 120 and projects into a third chamber 108c defined between the second wall 120 and an end wall 132 of the housing 106. A distal end of the actuating arm 122 defines a valve body 126 which selectively closes a conduit 134 defined through the end wall 132. The conduit 134 is fluidly connected to a fire suppressant reservoir 128 via a conventional pipe or hose.

The third chamber 108c is in fluid communication with the interior of the battery housing 104 and further defines a pressure release valve 130.

When the actuating arm 122 is in the configuration shown in FIG. 2a (i.e., with the frangible bulb 110 intact), the fire suppressant valve body 126 which controls the flow of a fire suppressant material from the reservoir 128 to the battery housing 104 is in a closed configuration which prevents the flow of the fire suppressant material into the third chamber 108c from the reservoir 128.

FIG. 2b shows the heat activated mechanical element 102 when the temperature within the battery housing 104 has exceeded a pre-determined threshold temperature and the frangible bulb 110 has shattered. In this case, the opposing force exerted by the frangible bulb 110 is removed and the biasing force exerted by the coil spring 118 urges the piston 112 into the first chamber 108a, which in turn displaces the actuating arm 122 in the same direction (i.e., towards the first chamber 108a).

The displacement of the actuating arm 122 causes the fire suppressant valve body 126 to move away from the end of the conduit 134, which in turn opens the end of the conduit 134 and permits the flow of fire suppressant material from the reservoir 128 into the interior of the battery housing 104 via the third chamber 108c.

FIGS. 3a and 3b show a third embodiment of the heat activated mechanical element 202.

The arrangement of the heat activated mechanical element 202 is similar to that of the heat activated mechanical element 102 described hereinabove.

Accordingly, the heat activated mechanical element 202 includes a housing 206, which passes through a wall of the battery housing 204 and is coupled thereto via a threaded coupling. The housing 206 defines a first chamber 208a within which a fire suppressant reservoir 228 is disposed. The fire suppressant reservoir 228 is closed by a valve 226 which is coupled to one end of a piston 212 which is also disposed in the first chamber 208a.

The piston 212 passes through a bore 214 defined through a wall 216 which defines one end of the first chamber 208a.

A frangible bulb 210 is disposed within a second chamber 208b which is defined between the wall 216 and a spaced apart opposing wall 220. The opposite end of the piston 212 defines an enlarged head portion 212a which is engaged on one side by a coil spring 218 and on the opposite side by one end of the frangible bulb 210. Thus, the coil spring 218 is located between the enlarged head 212a of the piston 212 and the wall 216, and the frangible bulb 210 is located between the other side of the enlarged head 212a of the piston 212 and the wall 220. The head portion 212a of the piston 212, the coil spring 218 and the frangible bulb 210 are all disposed in the second chamber 208b of the housing 206.

The coil spring 218 biases the enlarged head portion 212a of the piston 212 towards the frangible bulb 210. The biasing force exerted by the coil spring 218 is balanced by an opposing force exerted by the frangible bulb 210. Thus, the piston 212 remains stationary while the frangible bulb 210 remains intact (as shown in FIG. 3a).

Extending from the enlarged head portion 212a of the piston 212 through the wall 220 are a pair of intermediate actuating arms 222a and connected to the intermediate actuating arms 222a is a primary actuating arm 222 which in turn passes through a bore defined by the end wall 232 of the housing 206 and projects beyond the housing 206 and the battery housing 204. A distal end of the primary actuating arm 222 is operatively connected to an electrical switch 224. The electrical switch 224 selectively isolates an electrical circuit (not shown) from the electrochemical cells located within the battery housing 204.

A third chamber 208c is defined between the wall 220 and the end wall 232 which includes a pressure release valve 230.

The first chamber 208a and the third chamber 208c are both in fluid communication with the interior of the battery housing 204.

When the piston 212 is in the configuration shown in FIG. 3a (i.e., with the frangible bulb 210 intact), the fire suppressant valve body 226 which controls the flow of a fire suppressant material from the reservoir 228 to the interior of the battery housing 204 is in a closed configuration which prevents the flow of the fire suppressant material into the interior of the battery housing 204 via the first chamber 208a from the reservoir 228.

FIG. 3b shows the heat activated mechanical element 202 when the temperature within the battery housing 204 has exceeded a pre-determined threshold temperature and the frangible bulb 210 has shattered. In this case, the opposing force exerted by the frangible bulb 210 is removed and the biasing force exerted by the coil spring 218 urges the enlarged head 212a of the piston 212 away from the wall 216, which in turn displaces the piston 212 away from the fire suppressant valve body 226.

The displacement of the piston 212 away from the fire suppressant valve body 226 causes the fire suppressant valve body 226 to be urged away from the end of the reservoir 228 by the pressure of the fire suppressant material within the reservoir 228, which in turn opens the end of the reservoir 228 and permits the flow of fire suppressant material from the reservoir 228 into the interior of the battery housing 204 via the first chamber 208a.

Additionally, the displacement of the enlarged head 212a of the piston 212 away from the wall 216 causes the intermediate actuating arms 222a and the primary actuating arm 222b to move away from the wall 216. This displacement of the primary actuating arm 222b causes the configuration of the electrical switch 224 to change to an isolating configuration in which the electrical circuit is isolated from the electrochemical cells disposed within the battery housing 4.

FIG. 4 shows a battery assembly comprising a battery housing, the heat activated mechanical element 202 as shown in FIGS. 3a and 3b, and a plurality of electrochemical cells 340.

As shown in FIG. 4, the majority of the heat activated mechanical element 202 is disposed within a cavity 304a defined by the housing 304. However, the primary actuating arm 222b projects outside of the housing 304 and is operatively coupled to an electrical switch 324 which forms part of an electrical circuit (not shown) that is powered by the battery assembly.

The electrochemical cells 340 within the battery housing 304 are electrically connected to battery terminals 342, 344 in a conventional manner. The battery terminals provide electrical energy to the electric circuit that is powered by the battery assembly.

FIG. 5 shows a first embodiment 402 of a safety battery apparatus according to the fifth aspect of the invention. The apparatus 402 includes a housing 404 which defines therein a heat chamber 406 within which is located a frangible bulb 408.

At one end of the frangible bulb 408 is disposed an actuator element 410. Disposed between second end of the actuator element 410 and a wall 412 of the housing 404 is a spring 414.

The spring 414 is maintained under compression between the actuator element 410 and the wall 412 by the frangible tube 408.

The actuator element 410 defines a contact surface 416 which is adjacent to an operating arm (not shown) of an electrical switch 418.

If the temperature within the heat chamber 406 rises above a predetermined temperature as a result of heat energy generated in a rechargeable battery disposed adjacent to the safety battery apparatus 402, the frangible tube will shatter or break. In this event, the spring 414 is able to expand, which in turn drives the actuator element 410 away from the wall 412. This displacement of the actuator element causes the contact surface 416 to urge the operating arm of the electrical switch 418 into its isolation configuration, which isolates the battery from an electrical circuit (not shown) to which it is electrically connected.

FIG. 6 shows a second embodiment 502 of a safety battery apparatus according to the fifth aspect of the invention. The apparatus 502 is similar to that shown in FIG. 5 and includes a housing 504 which defines therein a heat chamber 506 within which is located a frangible bulb 508. The heat chamber 506 is identical in shape to the heat chamber 406, which is shown in more detail in FIG. 7.

Again, at one end of the frangible bulb 508 is disposed an actuator element 510. Disposed between second end of the actuator element 510 and a wall 512 of the housing 504 is a spring 514.

The spring 514 is maintained under compression between the actuator element 510 and the wall 512 by the frangible tube 508.

The actuator element 510 defines a contact surface 516 which is adjacent to an operating arm (not shown) of an electrical switch 518.

In this embodiment, the safety battery apparatus includes a thermally conductive wall 520 which is formed from aluminium. In use, the aluminium wall 520 is placed in contact with a wall of a rechargeable battery.

Additionally, the switch 518 is connected to a wireless transmitter 522. When the operating arm of the electrical switch 518 is moved to its isolation configuration, a wireless signal is sent by the wireless transmitter 522 to a wireless receiver (not shown) which forms part of the electrical circuit to which the battery is electrically connected. The wireless receiver then isolates the electrical circuit from the battery.

FIG. 7 shows the shape of the heat chamber 406. The heat chamber 406 is shaped so that the apparatus 402 (and also 502) may be placed in a vertical plane or a horizontal plane. In both orientations, the heat energy is collected and “focused” on the frangible tube 408.

FIG. 8a shows a first embodiment of a connector 602 which may be used to connect a safety battery apparatus 604 to a rechargeable battery (not shown).

The connector 602 includes a connector body 606 which defines an aperture 608. At a first end of the body 606 is located a channel-defining element 610 which defines therein a channel 612. At the opposite end of the body 606 is carried a resiliently deformable release tab 614 As can be seen in FIGS. 8b and 8c, the release tab 614 defines a locating lug 616.

FIGS. 8b and 8c show how the safety battery apparatus 604 is detachably coupled to the connector 602. The safety battery apparatus 604 includes a front rib 618 which is inserted into the channel 612 defined by the channel-defining element 610. A rear wall of the safety battery apparatus defines a tapered locating element 620. As the rear portion of the safety battery apparatus 604 is urged downwards, the tapered locating element 620 engages the locating lug 616 of the resiliently deformable release tab 614 and urges the release tab 614 to pivot rearwards. As soon as the tapered locating element 620 is disposed below the locating lug 616, the release tab 614 snaps back and a snap fit coupling is formed between the tapered locating element 620 of the safety battery apparatus 604 and the locating lug 616 of the release tab 614.

To remove the safety battery apparatus 604 from the connector 602, an upper part of the release tab 614 is urged rearwards until the locating lug 616 disengages from the tapered locating element 620. The rear of the safety battery apparatus 604 may then be urged upwards and the front rib 618 of the safety battery apparatus 604 may be removed from the channel 612.

FIG. 9a shows a second embodiment of a connector 702 which may be used to connect a safety battery apparatus 704 (shown in FIGS. 9b and 9c) to a rechargeable battery (not shown).

The connector 702 includes a connector body 706 which defines an aperture 712. The connector body 706 carries four magnetic projections 708 in the form of short cylinders.

FIGS. 9b and 9c show how the safety battery apparatus 704 is detachably coupled to the connector 702. The safety battery apparatus 704 includes four apertures (not shown) which correspond in position to the four magnetic projections 708. Each of the four apertures include a wall 710 which carries a magnetic material of opposite polarity to the magnetic projections 708.

In this way, each of the magnetic projections 708 is received within a respective aperture defined by the safety battery apparatus 704 and a magnetic coupling is formed between the opposing poles of the magnetic projections 708 and the walls 710.

To remove the safety battery apparatus 704 from the connector 702, an upwardly extending force is applied to the safety battery apparatus 704 which is greater than the magnetic coupling that is formed between the opposing poles of the magnetic projections 708 and the walls 710.

1. A safety battery apparatus comprising a battery housing within which is located one or more rechargeable electrochemical cells, and a heat safety apparatus associated with the battery housing, wherein the heat safety apparatus includes a heat detection apparatus and an electrical switch that forms part of an electrical circuit to which the electrochemical cell(s) are connected and/or forms part of an alarm circuit; the heat detection apparatus comprises a frangible bulb filled with a liquid or gas that is configured to shatter or break at a pre-determined temperature as a result of thermal expansion of a liquid or gas within the bulb, and a biasing element; the heat detection apparatus is operatively coupled to the electrical switch; the switch has an isolation configuration in which the switch isolates the electrical circuit from the electrochemical cells and/or activates the alarm circuit if a pre-determined threshold temperature within the battery housing is exceeded; the biasing element exerts a biasing force which urges the heat detection apparatus to configure the switch in its isolation configuration; the frangible bulb exerts a counterbalance force against the biasing force; and wherein the counterbalance force is removed when the frangible bulb shatters or breaks.

2. A safety battery apparatus according to claim 1, wherein the heat detection apparatus includes an actuator element which is operatively coupled to the electrical switch.

3. A safety battery apparatus according to claim 1, wherein the biasing element is a spring.

4. A safety battery apparatus according to claim 1, wherein the heat safety apparatus is carried externally on a wall of the battery housing.

5. A battery safety apparatus for use with a battery, wherein the battery safety apparatus comprises a housing which is connectable to the battery, wherein the housing contains a heat safety apparatus; wherein the heat safety apparatus includes a heat detection apparatus and an electrical switch that is connected to an electrical circuit to which the battery is connected and/or forms part of an alarm circuit; the heat detection apparatus comprises a frangible bulb filled with a liquid or gas that is configured to shatter or break at a pre-determined temperature as a result of thermal expansion of the liquid or gas within the bulb, and a biasing element; the heat detection apparatus is operatively coupled to the electrical switch; the switch has an isolation configuration in which the switch isolates the electrical circuit from the battery and/or activates the alarm circuit if a pre-determined threshold temperature within the housing is exceeded; the biasing element exerts a biasing force which urges the heat detection apparatus to configure the switch in its isolation configuration; the frangible bulb exerts a counterbalance force against the biasing force; and wherein the counterbalance force is removed when the frangible bulb shatters or breaks.

6. A battery safety apparatus according to claim 5, wherein the heat detection apparatus includes an actuator element which is operatively coupled to the electrical switch.

7. A battery safety apparatus according to claim 5, wherein the biasing element is a spring.

8. A battery safety apparatus according to claim 5, wherein the apparatus further includes a connector and the housing is detachably coupled to the connector.

9. A safety battery apparatus comprising a battery housing within which is located one or more rechargeable electrical energy storage cells, and a fire detection and suppression apparatus, wherein the fire detection and suppression apparatus comprises a heat activated mechanical element associated with the battery housing; a fire suppressor comprising a reservoir containing a fire suppressant material and a valve disposed between the reservoir and the battery housing, wherein the valve has a first configuration in which the fire suppressant material is prevented from entering the battery housing, and a second configuration in which the fire suppressant material is permitted to enter the battery housing; wherein the heat activated mechanical element is coupled to the valve and urges the configuration of the valve to change from its first configuration to its second configuration if a pre-determined threshold temperature within the battery housing is exceeded.

10. A safety battery apparatus according to claim 9, wherein the apparatus further includes an electrical switch that forms part of an electrical circuit to which the rechargeable electrical energy cell(s) located within the battery housing are connected and/or forms part of an alarm circuit; the heat activated mechanical element is operatively coupled to the switch; and the switch isolates the electrical circuit from the electrical energy cells and/or activates the alarm circuit if a pre-determined threshold temperature within the battery housing is exceeded.

11. A safety battery apparatus according to claim 9, wherein the heat activated mechanical element is disposed within a container.

12. A safety battery apparatus according to claim 9, wherein the heat activated mechanical element includes one or more heat sensitive components.

13. A safety battery apparatus according to claim 12, wherein the heat sensitive component includes a frangible bulb filled with a liquid or gas that is configured to shatter or break at a pre-determined temperature as a result of thermal expansion of the liquid or gas within the bulb; an alloy that is arranged to melt and fail at a predetermined temperature; an intumescent material; or a bimetallic strip.

14. A safety battery apparatus according to claim 12, wherein the heat activated mechanical element further includes an operative arm; wherein the operative arm is coupled to the heat sensitive component; and wherein the operative arm has an inactive configuration and an active configuration, wherein the operative arm is urged into its active configuration if a pre-determined threshold temperature within the battery housing is exceeded.

15. A safety battery apparatus according to claim 14, wherein the operative arm is biased towards its active configuration.

16. A safety battery apparatus according to claim 9, wherein the reservoir containing the fire suppressant material is located externally of the battery housing.

17. A safety battery apparatus according to claim 9, wherein the fire suppressant material is selected from a non-flammable gas, a non-flammable liquid, a non-flammable foam precursor, a non-flammable powder or mixtures thereof.

18. A safety battery apparatus according to claim 9, wherein the heat activated mechanical element is located within a cavity defined by a lid component of the battery housing.

19. A safety battery apparatus according to claim 18, wherein the lid component includes a heat directing element arranged around its periphery.

20. A safety battery apparatus according to claim 18, wherein the lid component includes a cover that covers the heat activated mechanical element.

21. A safety battery apparatus according to claim 20, wherein the cover is formed from a thermally insulating material.

22. A safety battery module comprising an array of two or more safety battery apparatus, wherein each safety battery apparatus comprises a battery housing within which is located one or more rechargeable electrical energy storage cells, and a fire detection and suppression apparatus, wherein the fire detection and suppression apparatus comprises a heat activated mechanical element associated with the battery housing; a fire suppressor comprising a reservoir containing a fire suppressant material and a valve disposed between the reservoir and the battery housing, wherein the valve has a first configuration in which the fire suppressant material is prevented from entering the battery housing, and a second configuration in which the fire suppressant material is permitted to enter the battery housing; wherein the heat activated mechanical element is coupled to the valve and urges the configuration of the valve to change from its first configuration to its second configuration if a pre-determined threshold temperature within the battery housing is exceeded; and wherein each valve is connected to a common reservoir containing the fire suppressant material.

23. A safety battery module according to claim 22, wherein the two or more safety battery apparatus are disposed within a container.

24. A battery energy storage system comprising two or more safety battery modules according to claim 23, wherein the modules are arranged vertically within a cabinet.
